(19) United States
(12) Patent Application Publication
(10) Pub. No.: US 2023/0220628 A1
(43) Pub. Date: Jul. 13, 2023

(54) COATING STRUCTURE, SHEET-LIKE PRODUCT AND ITS USE

(71) Applicant: KEMIRA OYJ, Helsinki (FI)

(72) Inventors: Jaakko HILTUNEN, Espoo (FI); Tarja TURKKI, Espoo (FI)

(21) Appl. No.: 18/007,775

(22) PCT Filed: Jun. 14, 2021
(86) PCT No.: PCT/FI2021/050440

§ 371 Date: Dec. 2, 2022

(30) Foreign Application Priority Data
Jun. 17, 2020 (FI) 20205643

(51) Int. Cl. D21H 19/34; D21H 19/38; D21H 19/46; D21H 19/52; D21H 19/82; D21H 27/10

(52) U.S. Cl. CPC D21H 19/34; D21H 19/38; D21H 19/46; D21H 19/52; D21H 19/82; D21H 27/10

(57) ABSTRACT

The present invention relates to a coating structure for a sheet-like substrate comprising cellulosic fibres. The coating structure comprises at least a first coating layer and a second coating layer, where the second coating layer is arranged in a direct contact with the first coating layer. At least the first coating layer or the second coating layer is a barrier coating layer comprising at least one water-soluble cellulose derivative selected from alkyl celluloses, hydroxyalkyl alkyl celluloses, hydroxyalkyl celluloses and any of their mixtures, and a plasticizer.

### CROSS REFERENCES

This application is a U.S. national stage application of international application number PCT/FI2021/050440 filed on Jun. 14, 2021 and claiming priority to Finnish national application number FI20205643 filed on Jun. 17, 2020.

### FIELD OF THE INVENTION

The present invention relates to a coating structure, a sheet-like product, and its use according to the preambles of enclosed independent claims.

### BACKGROUND OF THE INVENTION

Various coatings can be applied on the surface of paper or board in order to improve their properties. Grease barrier properties are particularly important for paper and board that are used for products for packaging purposes. Coatings applied on the surface of paper or board should provide an effective barrier against leakage from the goods inside the package and/or protect the packaged goods from contamination and/or contact with the surroundings. The barrier requirements are especially stringent for packaging materials used for foodstuff and consumable liquids.

Coatings for packaging purposes should have good resistance for creasing and folding. The coating should not crack when the paper or board is folded into a box or wrapped around the product. Cracking may decrease or even completely destroy the barrier properties of the coating.

Fluorochemicals or synthetic petroleum-based polymers have been conventionally used in coating compositions to provide desired barrier properties with simultaneous resistance to cracking. For environmental reason it would desirable to find effective alternatives for these petroleum-based chemicals. The alternatives should be sustainable and be based on renewable bio-based sources. Conventional bio-based components used in coating formulations, such as starch, often do not perform well in barriers coatings. They often make the coating brittle or inflexible, which leads to cracking of the coating at folding. Furthermore, the bio-based component should preferably originate from non-food chain sources, which requirement is not fulfilled by starch and starch derivatives. Consequently, there is a need for new alternatives that would solve the problems presently encountered.

Furthermore, the barrier coatings used for packages should also satisfy the recyclability requirements. Paper and board packages are ideally collected for recycling and repulped. Many traditional barrier coatings are problematic to repulp and/or require special process arrangements at repulping. The coatings applied on paper and board should fulfil the requirements of recycling and, for example, they should not disturb the repulping process.

### SUMMARY OF THE INVENTION

An object of this invention is to minimise or possibly even eliminate the disadvantages existing in the prior art.

Another object of the present invention is to provide a coating structure and a sheet-like product that are based on renewable raw materials and which are easily biodegradable and/or repulpable.

Still another object of the present invention is to provide a coating structure and a sheet-like product that provide good grease barrier properties.

Yet another object of the present invention is to provide a barrier coating structure, which can be used to create a coating that withstands cracking when creased and/or folded.

These objects are attained with the invention having the characteristics presented below in the characterising parts of the independent claims. Some preferred embodiments of the invention are presented in the dependent claims.

The embodiments mentioned in this text relate, where applicable, to all aspects of the invention, even if this is not always separately mentioned.

A typical coating structure according to the present invention for a sheet-like substrate, which comprises cellulosic and/or lignocellulosic fibres, comprises at least a first coating layer and a second coating layer, where the second coating layer is arranged in a direct contact with the first coating layer, and at least the first coating layer or the second coating layer is a barrier coating layer comprising
at least one water-soluble cellulose derivative selected from alkyl celluloses, hydroxyalkyl alkyl celluloses, hydroxyalkyl celluloses and any of their mixtures, and
a plasticizer.

A typical use of a coating structure according to present invention is for providing a grease barrier when applied on a sheet-like product comprising cellulosic and/or lignocellulosic fibres.

A typical sheet-like product according to the present invention comprises
a substrate comprising cellulosic and/or lignocellulosic fibres, and having a first large surface and a second large surface, which are parallel with each other, and
a coating structure according to the present invention applied at least on the first or the second large surface of the substrate.

A typical use of a sheet-like product according to the present invention is for making a foodservice package.

### DETAILED DESCRIPTION OF THE INVENTION

Now it has been surprisingly found out that a two-layered coating structure, comprising at least one barrier layer formed from a specific water-soluble cellulose derivative and a plasticizer, is able to effectively function as a grease barrier, especially against liquid grease or oil, and sometimes even as a mineral oil barrier. The use of the water-soluble cellulose derivative makes the coating structure easy to repulp and reduces the need for components from non-renewable sources. The water-soluble cellulose derivative is a bio-based component but originates from renewable non-food sources which is advantageous. Furthermore, it has been found that the simultaneous use of the specific water-soluble cellulose derivative and the plasticizer unexpectedly improves the properties of the coating structure, making it less tacky and reducing the risk for blocking. Also, the cracking tendency of the coating structure is significantly reduced, which improves the converting properties of the obtained coating structure.

The coating structure according to the present invention comprises at least a first coating layer and a second coating layer. The first coating layer is applied directly on the surface of a sheet-like substrate comprising cellulosic and/or lignocellulosic fibres. This means that the coating structure is preferably free of pre-coat and top coat layers and consists solely of the first coating layer and second coating layer, where the first coating layer is in contact with the surface of the substrate and the second coating layer forms the outer surface of the coating layer and subsequently the outer surface of the substrate. In some embodiments the surface of the sheet-like substrate may be surface sized, e.g. with a layer of hydrophobic surface size, before application of the first coating layer, but preferably the first coating layer is applied directly on the surface of a sheet-like substrate which is free from any pre-existing treatment layers, such as surface sizing layers. The sheet-like substrate may comprise an internal size. The first coating layer and the second coating layer may be applied on the surface of the substrate by using any conventional surface sizing or coating techniques, or their combinations. For example, the first coating layer can be applied by using a surface sizing device and the second coating layer may be applied by using a coating device, such as blade or rod coating device.

The second coating layer is arranged in a direct contact with the first coating layer, which means that it is applied directly on the surface of the first coating layer, in immediate and intimate contact with it. The coating structure is thus free of any intermediate layers between the first coating layer and the second coating layer.

The coating structure may comprise two or more first coating layers and/or two or more second coating layers. Preferably, if the coating structure comprises a plurality of first coating layers and/or plurality of second coating layers, the first coating layers are preferably chemically identical with each other and the second coating layers are preferably chemically identical with each other. Chemically identical means that the coating layers are made from same components in identical amounts, i.e. coating layers are made by using identical coating formulation. The coat weight within plurality of first coating layers and/or plurality of second coating layers may vary.

According to one preferable embodiment the first and second coating layers are identical with each other and they both are barrier coating layers. Use of two identical coating layers may enable the use of lower coat weights per individual layer while still obtaining the desired barrier effect. Furthermore, the risk for coating defects can be minimized when the coating structure comprises two or more identical coating layers.

According to one embodiment the first coating layer and the second coating layer are different from each other. For example, the first coating layer may comprise a different water-soluble cellulose derivative and/or plasticizer than the second coating layer. In this manner it is possible to tailor the properties of the coating structure to meet even very specific needs, e.g. in regard of barrier properties to be achieved.

The coat weight of the first coating layer and the second coating layer can be freely chosen depending on the desired end use and desired barrier properties. According to one embodiment of the invention the first coating layer may have a coat weight of 2-30 g/m², preferably 3-20 g/m², more preferably 5-15 g/m², and the second coating layer may have a coat weight of 0.5-20 g/m², preferably 0.5-15 g/m², more preferably 0.5-10 g/m². Typically, the first coating layer may have a higher coat weight than the second coating layer.

The coating structure of the present invention comprises at least one barrier coating layer. This means that the coating structure comprises at least two coating layers of which at least one is a barrier coating layer. At least the first coating layer or the second coating layer in the coating structure is a barrier coating layer. It is possible that the first coating layer is the barrier coating layer or that the second coating layer is the barrier coating layer according to the present invention. It is also possible that both the first coating layer and the second coating layer are barrier coating layers according to the present invention. The present invention provides possibilities to optimize the barrier properties of the coating structure by selecting the number and location of the barrier layers in the coating structure.

The barrier coating layer according to the present invention comprises at least one water-soluble cellulose derivative selected from a group consisting of alkyl celluloses, hydroxyalkyl alkyl celluloses, hydroxyalkyl celluloses and any of their mixtures. The water-soluble cellulose derivative may preferably be selected from of group consisting of methyl cellulose, hydroxymethyl cellulose, hydroxyethyl cellulose, hydroxypropyl cellulose, (hydroxyethyl)methyl cellulose, and (hydroxypropyl)methyl cellulose and any mixtures thereof. Preferably the water-soluble cellulose derivative is methyl cellulose, (hydroxypropyl)methyl cellulose or hydroxyethyl cellulose, more preferably hydroxyethyl cellulose. It has been observed that when one of the specified water-soluble cellulose derivatives is present in the barrier coating layer, the layer is more flexible and does not crack so easily at creasing or folding. Moreover, the specified cellulose derivatives provide increased dry solid content for the coating formulation, thus making it easier to apply on the surface of the substrate to be coated and providing for a better film forming properties.

Especially use of (hydroxypropyl)methyl cellulose may provide coating that show mineral oil barrier properties and which therefor may be suitable also on technical applications.

The cellulose derivatives suitable for the present invention are water-soluble at least at room temperature (+21° C.). In the present context, the term “water-soluble cellulose derivative” denotes cellulose derivatives that dissolve in water without gel formation. Unsaturated solution (in water) of the water-soluble cellulose derivative, at temperature +21° C. is free of solid particles and it is filterable through a filter with 100 micron openings. Methyl cellulose and (hydroxypropyl)methyl cellulose become water insoluble in hot water (about +75° C.), but they are still suitable for use for the present invention, and may even provide limited water barrier properties, especially against hot liquids, for the coating layer in addition the grease barrier properties.

The barrier coating layer comprising water-soluble cellulose derivative, i.e. the first coating layer and/or the second coating layer, is preferably formed without use of organic solvents. Typically the barrier coating layer is formed by using an aqueous solution of water-soluble cellulose derivative which is free of organic solvents.

The first coating layer and the second coating layer may both be barrier coating layers, which comprise water-soluble cellulose derivatives, which are chemically identical. Alternatively, the first coating layer and the second coating layer may both be barrier coating layers, where the first barrier coating layer comprises a first water-soluble cellulose derivative and the second barrier coating layer comprises a second water-soluble cellulose derivative. The first and second water-soluble cellulose derivatives are different from each other and selected from the group of alkyl celluloses, hydroxyalkyl alkyl celluloses, hydroxyalkyl celluloses and any of their mixtures.

The barrier coating layer, i.e. the first and/or second coating layer, may comprise water-soluble cellulose derivative in amount of 50-99 weight-%, preferably 60-97 weight-%, more preferably 70-95 weight-% or 80-95 weight-%, calculated from total solids content of the barrier coating layer. With the present invention it is possible to produce coating structures where the content of bio-based components is high while maintaining the essential barrier and crack resistance properties at least on an acceptable level.

In addition to the water-soluble cellulose derivative the barrier coating layer comprises a plasticizer. The plasticizer is incorporated in the barrier coating layer between the water-soluble cellulose derivative chains, where it spaces them apart and controls their mobility in the barrier coating layer. The selected plasticizer is preferably suitable for food packaging purposes, which means, for example, that phthalate esters are excluded. The plasticizer may be selected from a group comprising polyols, such as sorbitol, mannitol, ethylene glycol, diethylene glycol, triethylene glycol, tetraethylene glycol, propylene glycol or polyethylene glycol; fatty acids; monosaccharides, ethanolamine; triethanolamine; alkyl citrates, urea; lecithin and glycerol. According to one preferable embodiment the plasticizer may be selected from sorbitol, polyethylene glycol or glycerol. Often the incorporation of a plasticizer into a barrier coating layer makes the barrier coating layer too tacky which may easily lead to blocking problems. Now it has been unexpectedly observed that the tackiness of the barrier coating layer comprising plasticizer is significantly decreased when the barrier coating layer comprises the water-soluble cellulose derivative. This means that it is possible to obtain a coating layer where the cracking and blocking resistance properties can be balanced with the flexibility in order to obtain a coating structure with optimal properties for the desired purpose.

The barrier coating layer may comprise plasticizer in amount of 1-50 weight-%, preferably 3-40 weight-%, more preferably 5-30 weight-% or 5-20 weight-%, calculated from total solids content of the barrier coating layer.

According to one preferable embodiment of the present invention at least the barrier coating layer may further comprise inorganic pigment particles. The inorganic mineral pigment may be selected from kaolin, talc, calcium carbonate or any mixture thereof, preferably calcium carbonate, such as ground calcium carbonate or precipitated calcium carbonate. The particle size D50 of the inorganic pigment particles may be <5 μm. According to one embodiment the barrier coating layer may comprise inorganic mineral particles, wherein at least 45% of the inorganic mineral particles has particle size <2 μm. Addition of inorganic mineral pigment may further improve the obtained barrier properties. It has been unexpectedly observed that the water-soluble cellulose derivatives increase the flexibility of the barrier coating layer in a manner that allows incorporation of high amounts of inorganic pigment particles to the barrier coating layer. This may not only improve the barrier properties, but also makes the coating structure more economic to produce.

The first coating layer and the second coating layer may both contain inorganic mineral particles, irrespective if they are both barrier coating layers according to the present invention or not. The inorganic mineral particles, their type and/or amount, in the first coating layer and in the second coating layer may be same or different. Preferably, the first coating layer and the second coating layer comprise identical inorganic mineral particles, even if their amount may be different in the first and the second coating layer.

According to one preferable embodiment at least the second coating layer, which is directly applied on the first coating layer(s), may be a barrier coating layer which comprises inorganic pigment particles, preferably calcium carbonate particles. In this case the first coating layer may function as a sealing layer, which reduces or prevents the penetration of the barrier coating layer to the surface of the substrate to be coated.

According to one embodiment of the present invention the water-soluble cellulose derivative may be selected from alkyl celluloses, such as methyl cellulose, wherein the barrier coating layer may comprise inorganic pigment particles in an amount of 5-20 weight-%, preferably 7-17 weight-%, more preferably 7-15 weight-%, calculated from the total dry solids content of the barrier coating layer. For example, the barrier coating layer may comprise 50-90 weight-%, preferably 60-90 weight-% or 75-87 weight-% of alkyl cellulose, such as methyl cellulose, 5-20 weight-% preferably 7-17 weight-% or preferably 7-15 weight-% of inorganic pigment particles, and 5-30 weight-%, preferably 5-25 weight-% or 5-20 weight-% of plasticizer, calculated from the total dry solids content of the barrier coating layer, the total amount of the components adding up to 100%.

According to an another embodiment of the present invention the water-soluble cellulose derivative is preferably selected from hydroxyalkyl celluloses or hydroxyalkyl alkyl celluloses, such as hydroxyethyl cellulose or (hydroxypropyl)methyl cellulose, wherein the barrier coating layer may comprise inorganic pigment particles in an amount of 20-60 weight-%, preferably 30-55 weight-%, more preferably 40-50 weight-%, calculated from the total dry solids content of the barrier coating layer. For example, the barrier coating layer may comprise 20-60 weight-%, preferably 30-55 weight-% or 40-50 weight-% of or hydroxyalkyl alkyl celluloses, such as hydroxyethyl cellulose or (hydroxypropyl)methyl cellulose, 20-50 weight-%, preferably 35-50 weight-% or 30-50 weight-% of inorganic pigment particles, and 5-30 weight-%, preferably 10-30 weight-% or 15-26 weight-% of plasticizer, calculated from the total dry solids content of the barrier coating layer, the total amount of the components adding up to 100%. Use of hydroxyalkyl cellulose or hydroxyalkyl alkyl cellulose enable the use of high levels of inorganic pigment particles in the barrier coating layer without deterioration of the coating layer properties, such as cracking resistance.

Starch may increase the brittleness of the coating structure and reduce the coating structures resistance for cracking. Therefore, the amount of starch in the coating structure according to the present invention is preferably minimised. More preferably the first and the second coating layers of the coating structure are free of starch.

According to one embodiment of the invention the first coating layer of the coating structure may comprise carboxymethyl cellulose provided that the second coating layer is a barrier coating layer according to the present invention and free of carboxymethyl cellulose. According to another preferable embodiment of the invention the both the first coating layer and the second coating layer of the coating structure are completely free of carboxymethyl cellulose.

According to one embodiment of the invention at least the barrier coating layer may further comprise an additional coating binder, preferably polyvinyl alcohol. The weight average molecular weight of the polyvinyl alcohol may be <100 000 g/mol, preferably <90 000 g/mol. Polyvinyl alcohol that is especially suitable for use as an additional coating binder may have a weight average molecular weight of 70 000 g/mol, preferably 13 000-70 000 g/mol. Polyvinyl alcohol may be at least partially hydrolysed. Polyvinyl alcohol, when used as an additional coating binder, may improve the film formation and both water vapour and mineral oil barrier properties of the coating layer. Polyvinyl alcohol may also reduce blocking tendency of the obtained coating structure. According to one embodiment, the first and/or second coating layer is free of polyvinyl alcohol.

According to a further embodiment the coating layer may comprise one or more of the following additive agents: thickener(s), cross-linker(s), lubricant(s), alkyl ketene dimer(s), alkenyl succinic anhydride(s), and dispersing agent(s). Preferably, the first and second coating layers are free of animal-based additives and/or components, such as animal-based chitosan or gelatine. Exclusion of animal-based additives makes the coating structure suitable for foodservice packaging products intended for all consumer groups, irrespective of their religion or ideology.

The coating structure may further comprise one or more additional coating layers that are applied on the surface of the second coating layer. The additional coating layer(s) may be different from the second coating layer.

According to one preferable embodiment, the coating structure is free of additive agents that are synthetic polymers. Especially the coating structure may be free of synthetic polymers based on styrene, such as styrene-butadiene or styrene-acrylate latices. Exclusion of synthetic polymers may improve the biodegradability and/or compostability of the coating structure and make it more environmentally friendly, even if disposed in unproper manner by the end consumer. Exclusion of styrene-based polymers makes the coating structure also safe to produce. Especially, according to one embodiment of the present invention the coating structure is free from any layers of laminated polymer films. This improves the repulpability and compostability of the coating structure.

The substrate for the coating structure according to the present invention may comprise cellulosic and/or lignocellulosic fibres. The cellulosic or lignocellulosic fibres may have been obtained by any conventional pulping process, including chemical, mechanical, chemi-mechanical pulping processes. The substrate may also comprise or consist of recycled fibres. The substrate has a first and a second large surface, parallel with each other, and it is usually in form of a fibrous web. The substrate may have a grammage of 25-800 g/m², preferably 30-700 g/m², more preferably 40-500 g/m². The coating structure may be applied at least on the first and/or the second large surface of the substrate by using any conventional surface sizing techniques or coating techniques, such as rod coating, blade coating, spray coating or curtain coating.

According to one preferable embodiment the obtained sheet-like product coated with the coating structure may have TAPPI 559 KIT test value of at least 8, preferably at least 10, more preferably at least 12. The KIT test value measures the repellency of the coating to oil and grease and the measurements are performed according to standard TAPPI method T-559 pm-96.

According to one preferable embodiment the obtained sheet-like product coated with the coating structure may have a mineral oil barrier HVTR value <100 g/m²/d. The used Hexane Vapour Transmission Rate (HVTR) value is obtained by using test method developed by BASF. In the test hexane is placed in a measurement cup covered by barrier sample, and the evaporation of hexane through the known area is measured. The test method is commonly known for persons skilled in the art.

According to one preferable embodiment the obtained sheet-like product coated with the coating structure may have a water vapour barrier at 23° C. and 50% relative humidity WVTR value <100 g/m²/d. WVTR value can be measured by using standard methods of ASTM F-1249, ISO 15105-2, ISO 15106-3, DIN 53122-2.

The sheet-like product coated with the coating structure can be used for making a foodservice package or for liquid packaging. Typical examples of foodservice packages are packages for fast food, ready-to-eat meals, sandwiches, bakery products, such as cookies, doughnuts, or the like.

In the present context, if not otherwise stated, all weight-% values given for the various components are calculated from the total dry solids content of the coating layer.

### EXPERIMENTAL

Some embodiments of the invention are described in the following non-limiting examples.

Preparation of Cellulose Derivative Solutions

Used cellulose derivatives were dissolved in water. Cellulose derivatives were dissolved at maximum solids content, which produced a cellulose derivative solution with a Brookfield viscosity below 1000 mPas at room temperature. The dissolving procedures are described below and the used cellulose derivates and properties of the obtained cellulose derivative solutions are described in Table 1.

Methyl cellulose (MEC); (Hydroxypropyl) methyl cellulose (HPMC): ⅓ of used total water amount was heated close to boiling temperature and cellulose derivative powder was added under mixing to avoid lump formation. The obtained suspension was placed in an ice bath and mixing was continued until the all cellulose derivative powder had dissolved. Remaining amount of the total water amount was added under mixing.

Hydroxyethyl cellulose (HEC): Cellulose derivative powder was added to water under mixing and the obtained suspension of was heated to 60° C. and kept at that temperature until the dissolution of the derivative was complete.

TABLE 1
Properties of the obtained cellulose derivative solutions.

| | Solids Content | Viscosity Br100* |
|---|---|---|
| Cellulose Derivative | [weight-%] | [mPas] |
| Methyl cellulose MEC | 6.5 | 410 (+19° C.) |
| (Hydroxypropyl) methyl cellulose | 4.6 | 758 (+21° C.) |
| HPMC | | |
| 2-hydroxyethyl cellulose HEC | 10 | 911 (+22° C.) |

*viscosity measurement temperature given in parenthesis

Preparation and Measurement of Coating Layers

Coating formulations used in the examples were prepared by using Diaf dissolvers for mixing.

A Brookfield DV-E (Brookfield GmbH, Lorch, Germany) viscometer was used for measurement of the bulk viscosity of the coating formulation immediately after its preparation. Different spindles were used in accordance with the viscosity range of the respective sample. The measurements were performed at 100 rpm.

Laboratory coating tests were carried out by using draw down coater K control coater (RK Print Coat Instruments, Litlington, UK) with different wound rods and coating speeds. Samples were dried using InfraRR IR dryer for 60 seconds. All samples were double coated. The used substrate in coating tests was virgin fibre based cartonboard, basis weight of 295 g/m². Barrier coating layers were applied on the uncoated bottom side of the substrate.

Coat weight of a coated substrate was determined by weighting the coated sample and uncoated base paper and coat weight was obtained by the weight difference. Simple converting test was done for the samples including sample creasing using Cyklos CPM 450 creasing and perforation unit. Creasing and folding was done in machine and cross directions. Staining test was done for the creased samples by using methyl red dissolved in ethanol. For folding Cobb roller was used to give uniform folding pressure.

Water resistance of the coated substrate was tested using Cobb60 test, according to standard ISO 535.

Water vapor barrier properties, WVTR, of the coated substrate were measured using Systech Permeation Analyzers M7002 instrument.

Hexane vapor transmission rate of the coated substrate was determined by using a cup method. 20 grams of hexane was placed in a metal cup. Coated substrate was placed on top of the cup between two gaskets, coated side down. Metal frame was used to tighten the sample to the cup. Weight loss was recorded for 24 hours.

Grease barrier properties of the coated substrates are given as KIT values.

Blocking tests were carried out at 40° C. temperature and 150 bar pressure for four hours. The coated sample is coated with barrier coating on one side and with top side coating on the other side. The barrier coated sample was placed against the top side coating in the test. Used scale for blocking test results is shown in Table 2.

TABLE 2
Blocking test scale used in Examples.

| Result | Explanation |
|---|---|
| 1 | Samples did not adhere together |
| 2 | There is a noise when pulling the sample apart |
| 3 | Coating defect <50% of the surface area |
| 4 | Coating defect >50% of the surface area |
| 5 | Base paper delamination |

### Example 1: Impact of Different Plasticizers to Coating Layer Properties

Impact of different plasticizers were tested with low molecular weight hydroxypropyl methyl cellulose, HPMC. Glycerol, sorbitol, and polyethylene glycol were selected as plasticizers. Coating formulations comprised 20 weight-% of plasticizer and 80 weight-% of HPMC. All samples were double coated.

Obtained coat weights and barrier properties are shown in Table 3. Good film formation was obtained with all tested plasticizers.

TABLE 3
Coat weights and barrier properties for samples of Example 1.

| | | Coat weight | |
|---|---|---|---|
| Sample | Plasticizer | [g/m²] | KIT |
| 1-1 | Glycerol | 10.0 | 12 |
| 1-2 | Sorbitol | 8.6 | 12 |
| 1-3 | PEG300 | 7.6 | 12 |

It can be seen from Table 3 that all coating layers with different plasticizer showed good grease barrier properties.

### Example 2: Impact of Inorganic Pigment Addition to Coating Layer Properties

Impact of inorganic pigment addition was tested for following cellulose derivatives: hydroxypropyl methyl cellulose HPMC, methyl cellulose MEC and hydroxyethyl cellulose HEC. Ground calcium carbonate (HydroCarb 60, Omya) was used as an inorganic pigment. All coating formulations comprised 20 weight-% of plasticizer. In coating formulations comprising HPMC or HEC plasticizer was PEG300; in coating formulations comprising MEC plasticizer was D-sorbitol. Amount of cellulose derivative and inorganic pigment in the coating formulations are shown in Table 4. All samples were double coated.

Obtained coat weights and barrier properties are shown in Table 4.

TABLE 4
Coating formulations, obtained coat weights and
barrier properties for samples of Example 2.

| | | Cellulose | | | | |
|---|---|---|---|---|---|---|
| | Cellulose | Derivative, | Inorganic Pigment, | Coat weight, | KIT | |
| Sample | Derivative | welght-% | weight-% | g/m² | (flat) | Blocking |
| 2-1 | HPMC | 70 | 10 | 9.6 | 12 | — |
| 2-3 | HPMC | 70 | 10 | 8.9 | — | — |
| 2-4 | HPMC | 70 | 10 | 9.7 | — | 1 |
| 2-5 | HPMC | 60 | 20 | 10.9 | 12 | — |
| 2-6 | HPMC | 60 | 20 | 11.5 | — | — |
| 2-7 | HPMC | 60 | 20 | 11.1 | — | 1 |
| 2-8 | HPMC | 50 | 30 | 12.9 | 12 | — |
| 2-9 | HPMC | 50 | 30 | 11.8 | — | — |
| 2-10 | HPMC | 50 | 30 | 12.2 | — | 1 |
| 2-11 | MEC | 70 | 10 | 5.2 | 9 | — |
| 2-12 | MEC | 70 | 10 | 10.5 | 8 | 1 |
| 2-13 | MEC | 60 | 20 | 5.3 | 8 | — |
| 2-14 | MEC | 60 | 20 | 9.7 | 8 | — |
| 2-15 | MEC | 50 | 30 | 6.7 | 9 | — |
| 2-16 | MEC | 50 | 30 | 10.8 | 7 | — |
| 2-17 | HEC | 70 | 10 | 6.1 | 4 | — |
| 2-18 | HEC | 70 | 10 | 7.3 | 12 | — |
| 2-19 | HEC | 70 | 10 | 13.5 | 12 | 2 |
| 2-20 | HEC | 60 | 20 | 6.9 | 3 | — |
| 2-21 | HEC | 60 | 20 | 9.5 | 12 | — |
| 2-22 | HEC | 60 | 20 | 14.8 | 12 | 2 |
| 2-23 | HEC | 50 | 30 | 6.5 | 4 | — |
| 2-24 | HEC | 50 | 30 | 10.8 | 12 | — |
| 2-25 | HEC | 50 | 30 | 18.7 | 12 | 2 |

It can be seen from Table 4 that none of the tested HPMC or HEC samples showed cracking at crease up to pigment content of 30 weight-%. KIT values of 12 were obtained for all pigment addition levels for double coated coating structures with HPMC and HEC. HPMC and HEC samples showed good grease barrier properties.

MEC sample comprising 10 weight-% of inorganic pigment did not show cracking at crease, while MEC samples with higher inorganic pigment content showed some cracking at crease. KIT values 7-8 were obtained for all pigment addition levels for double coated coating structures with MEC.

### Example 3: Coating Structure with High Amount of Inorganic Pigment and an Additional Binder

A higher pigment content in the coating structure was tested with hydroxyethyl cellulose and hydroxypropyl methyl cellulose coating formulations. Ground calcium carbonate GCC (HydroCarb 60, Omya) was used as an inorganic pigment. The impact of the presence of an additional binder in the coating layer was also tested. The coating formulations for making the coating layers are presented in Table 5.

TABLE 5
Coating formulations used in Example 3

| | Coating Formulation | | | |
|---|---|---|---|---|
| Coating Component | HEC A | HEC B | HPMC A | HPMC B |
| Hydroxyethyl cellulose | 55 | 40 | | |
| Hydroxypropyl methyl cellulose | | | 50 | 50 |
| GCC | 35 | 40 | 35 | 30 |
| PEG-300 | 10 | 20 | 15 | 10 |
| Additional Binder, polyvinyl alcohol | | | | 10 |

Obtained coat weights and barrier properties for double coated samples are shown in Table 6. HVTR values <100 g/m² are considered to indicate good barrier properties against mineral oil.

TABLE 6
Coating formulations, obtained coat weights and
barrier properties for samples of Example 3.

| Coating | Coat weight | KIT | WVTR | | HVTR |
|---|---|---|---|---|---|
| Formulation | g/m² | (flat) | g/m²/d | Blocking | g/m²*d |
| HPMC A | 12.4 | 12 | 143 | — | — |
| HPMC A | 11.5 | 12 | — | — | 22 |
| HPMC A | 11.7 | 12 | — | 1 | — |
| HPMC B | 11.8 | 12 | 133 | 1 | — |
| HPMC B | 12.0 | 12 | — | — | 92 |
| HEC A | 4.9 | 5 | — | — | — |
| HEC A | 6.8 | 12 | — | — | 3 |
| HEC A | 6.9 | 12 | — | 1 | — |
| HEC B | 5.4 | 5 | — | — | — |
| HEC B | 9.4 | 12 | 107 | — | 11 |
| HEC B | 10.5 | 12 | — | 1 | — |

It can be seen from the results in Table 6 that both HPMC and HEC give good grease barrier as well as mineral barrier properties. Furthermore, the blocking results are good, and the coatings do not crack during creasing.

### Example 4: Coating Structure with High Amount of Inorganic Pigment

An inorganic pigment content up to 50 weight-% in the coating structure was tested with hydroxyethyl cellulose and hydroxypropyl methyl cellulose coating formulations. Ground calcium carbonate GCC (HydroCarb 60, Omya) was used as an inorganic pigment. The impact of the presence of an additional binder in the coating layer was also tested. The coating formulations for making the coating layers are presented in Table 7.

TABLE 7
Coating formulations used in Example 4

| | Coating Formulation | | | | | |
|---|---|---|---|---|---|---|
| Coating Component | HEC C | HEC D | HPMC C | HPMC D | HPMC E | HPMC F |
| Hydroxyethyl cellulose | 40 | 45 | | | | |
| Hydroxypropyl | | | 45 | 35 | 40 | 30 |
| methylcellulose | | | | | | |
| GCC | 50 | 45 | 40 | 50 | 40 | 50 |
| PEG-300 | 10 | 10 | 15 | 15 | 10 | 10 |
| Additional Binder, | | | | | 10 | 10 |
| polyvinyl alcohol | | | | | | |

Obtained coat weights and barrier properties for double coated samples are shown in Table 8.

It can be seen from the results in Table 8 that the coating formulations had good grease barrier as well as mineral barrier properties. Furthermore, the blocking results are good.

TABLE 8
Coating formulations, obtained coat weights and
barrier properties for samples of Example 4.

| | Coat | | | | |
|---|---|---|---|---|---|
| Coating | weight | KIT | WVTR | | HVTR |
| Formulation | g/m² | (flat) | g/m²/d | Blocking | g/m²*d |
| HEC C | 7.0 | 5 | — | — | — |
| HEC C | 11.5 | 12 | 105 | — | 13 |
| HEC C | 11.5 | 12 | — | 1 | — |
| HEC D | 5.4 | 4 | — | — | — |
| HEC D | 9.9 | 12 | 111 | — | 11 |
| HEC D | 9.9 | 12 | — | 1 | — |
| HPMC C | 10.9 | 12 | 143 | — | 24 |
| HPMC C | 11.4 | 12 | — | 1 | — |
| HPMC C | 9.6 | 12 | — | — | — |
| HPMC D | 14.7 | 12 | 153 | — | 30 |
| HPMC D | 11.8 | 12 | — | 1 | — |
| HPMC D | 10.3 | 12 | — | — | — |
| HPMC E | 13.7 | 12 | 133 | — | 142 |
| HPMC E | 11.3 | 12 | — | 1 | — |
| HPMC E | 10.7 | 10 | — | — | — |
| HPMC F | 15.9 | 12 | — | — | — |
| HPMC F | 14.9 | 12 | 138 | — | 253 |
| HPMC F | 12.4 | 12 | — | 1 | — |

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. A coating structure for a sheet-like substrate comprising cellulosic and/or lignocellulosic fibres, the coating structure comprising at least a first coating layer and a second coating layer, where the second coating layer is arranged in a direct contact with the first coating layer, and at least the first coating layer or the second coating layer is a barrier coating layer comprising
at least one water-soluble cellulose derivative selected from alkyl celluloses, hydroxyalkyl alkyl celluloses, hydroxyalkyl celluloses and any of their mixtures, and
a plasticizer.

2. The coating structure according to claim 1, wherein the water-soluble cellulose derivative is selected from of the group consisting of methyl cellulose, hydroxymethyl cellulose, hydroxyethyl cellulose, hydroxypropyl cellulose, (hydroxyethyl)methyl cellulose, (hydroxypropyl)methyl cellulose, and any mixtures thereof.

3. The coating structure according to claim 1, wherein the barrier coating layer comprises water-soluble cellulose derivative in amount of 50-99 weight-%, preferably 60-97 weight-%, more preferably 70-95 weight-%, calculated from total solids content of the barrier coating layer.

4. The coating structure according to claim 1, wherein the plasticizer of the barrier coating layer is selected from polyol, such as sorbitol, mannitol, ethylene glycol, diethylene glycol, triethylene glycol, tetraethylene glycol, propylene glycol or polyethylene glycol; fatty acids; monosaccharides, ethanolamine; triethanolamine; urea; lecithin and glycerol.

5. The coating structure according to claim 1, wherein the barrier coating layer comprises plasticizer in amount of 1-50 weight-%, preferably 3-40 weight-%, more preferably 5-30 weight-% or 5-20 weight-%, calculated from total solids content of the barrier coating layer.

6. The coating structure according to claim 1, wherein at least the barrier coating layer further comprises inorganic pigment particles.

7. The coating structure according to claim 6, wherein the water-soluble cellulose derivative is selected from alkyl celluloses, such as methyl cellulose, wherein the barrier coating layer comprises inorganic pigment particles in an amount of 5-20 weight-%, preferably 7-17 weight-%, more preferably 7-15 weight-%, calculated from a total dry solids content of the barrier coating layer.

8. The coating structure according to claim 6, wherein the water-soluble cellulose derivative is selected from hydroxyalkyl celluloses or hydroxyalkyl alkyl celluloses, and wherein the barrier coating layer comprises inorganic pigment particles in an amount of 20-60 weight-%, preferably 30-55 weight-%, more preferably 40-50 weight-%, calculated from the total dry solids content of the barrier coating layer.

9. The coating structure according to claim 1, wherein the first coating layer and the second coating layer are barrier coating layers.

10. The coating structure according to claim 1, wherein the first coating layer has a coat weight of 2-30 g/m², preferably 3-20 g/m², more preferably 5-15 g/m², and the second coating layer has a coat weight of 0.5-20 g/m², preferably 0.5-15 g/m², more preferably 0.5-10 g/m².

11. The coating structure according to claim 1, wherein the coating structure provides a grease barrier when applied on a sheet-like product comprising cellulosic and/or lignocellulosic fibres.

12. A sheet-like product comprising
a substrate comprising cellulosic and/or lignocellulosic fibres, and having a first large surface and a second large surface, which are parallel with each other, and
a coating structure according to claim 1 applied at least on the first or the second large surface of the substrate.

13. The sheet-like product according to claim 12, wherein the substrate has a grammage of 25-800 g/m², preferably 30-700 g/m², more preferably 40-500 g/m².

14. The sheet-like product according to claim 12, wherein the product has KIT test value of at least 8, and/or mineral oil barrier HVTR value <100 g/m²/d.

15. A foodservice package made of or comprising sheet-like product according to claim 12.
